(19) United States
(12) Patent Application Publication
(10) Pub. No.: US 2026/0323520 A1
(43) Pub. Date: Oct. 15, 2026

(54) METHOD AND APPARATUS FOR LOW POWER WAKE UP TECHNOLOGY

(71) Applicant: Samsung Electronics Co., Ltd., Suwon-si, Gyeonggi-do (KR)

(72) Inventors: Min WU, Beijing (CN); Pengru LI, Beijing (CN); Feifei SUN, Beijing (CN)

(21) Appl. No.: 19/104,542

(22) PCT Filed: Aug. 16, 2023
(86) PCT No.: PCT/KR2023/012122

§ 371 Date: Feb. 18, 2025

(30) Foreign Application Priority Data
Aug. 18, 2022 (CN) 202210995450.3

(51) Int. Cl. H04W 52/02; H04W 72/23

(52) U.S. Cl. CPC H04W 52/0235; H04W 72/23

(57) ABSTRACT

The disclosure relates to a 5G or 6G communication system for supporting a higher data transmission rate. The disclosure provides a method performed by a user equipment (UE), including monitoring a wake up signal including at least one data signal, wherein the data signal carries wake up information for at least one UE or at least one UE group, or common wake up information; performing a corresponding behavior based on the wake up information carried by the at least one data signal.

### TECHNICAL FIELD

The present application relates generally to wireless communication systems and, more specifically, the present disclosure relates to a method and apparatus for a low power wake up signal in wireless communication.

### BACKGROUND ART

5G mobile communication technologies define broad frequency bands such that high transmission rates and new services are possible, and can be implemented not only in “Sub 6GHz” bands such as 3.5GHz, but also in “Above 6GHz” bands referred to as mm Wave including 28GHz and 39GHz. In addition, it has been considered to implement 6G mobile communication technologies (referred to as Beyond 5G systems) in terahertz bands (for example, 95GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial In-telligence) from the design stage and internalizing end-to-end AI support functions, and next-generation distributed computing technology for implementing services at levels of complexity exceeding the limit of UE operation capability by utilizing ultra-high-performance communication and computing resources.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FQAM) and sliding window su-perposition coding (SWSC) as advanced coding modulation (ACM), and filter bank multicarrier (FBMC), non-orthogonal multiple access (NOMA) and sparse code multiple access (SCMA) as advanced access technologies have been developed.

### DISCLOSURE OF INVENTION

### Technical Problem

The present invention has been made to address at least the above problems and/or disadvantages and to provide at least the advantages described below. Accordingly, an aspect of the present invention provides a method and apparatus for low power wake up technology.

### Solution to Problem

According to an embodiment of the present disclosure, a method performed by a user equipment (UE) is provided, may include monitoring a wake up signal including at least one data signal, wherein the data signal carries wake up information for at least one UE or at least one UE group, or common wake up information; and performing a corresponding behavior based on the wake up information carried by the at least one data signal.

In an implementation, wherein the wake up signal may further include a synchronization signal which is followed by the at least one data signal and transmitted based on a physical signal sequence.

In an implementation, wherein there is a preset interval between the synchronization signal included in the wake up signal and the data signal included in the wake up signal, the preset interval being predefined, preconfigured, or reported by the UE; and/ or the synchronization signal included in the wake up signal and the data signal included in the wake up signal meet a requirement of a minimum preset interval which is predefined, or reported by the UE.

In an implementation, the synchronization signal and/or the at least one data signal are On-Off Keying (OOK) modulated.

The method according to the embodiment of the present disclosure may further include receiving the wake up signal through a lower power receiver (LPR), wherein the LPR activates a primary communication receiver (PCR) if the UE is waked up based on an indication of the wake up signal.

In an implementation, wherein the performing of the corresponding behavior includes: performing a predefined behavior; or performing a behavior indicated by the at least one data signal.

In an implementation, wherein the wake up signal includes multiple data signals which are used to wake up different UEs or UE groups, respectively, wherein the number of the multiple data signals is predefined, preconfigured by system information, or preconfigured by UE-specific radio resource control (RRC) signaling, or, the first data signal of the multiple data signals indicates information related to the number of the multiple data signals.

In an implementation, wherein: there is a preset interval between two adjacent data signals of the multiple data signals, the preset interval being predefined, preconfigured, or reported by the UE; and/or two adjacent data signals of the multiple data signals meet a requirement of a minimum preset interval which is predefined or reported by the UE.

In an implementation, wherein the data signal has multiple formats, and the data signal in different formats is used to carry information bits with different wake up functions; and wherein each format includes at least one indication field, and the number of information bits included in the indication field is predefined or pre-configured.

In an implementation, wherein the multiple formats include at least one of: a format for carrying cell common wake up information; a format for carrying the wake up information for at least one UE or at least one UE group; a format for waking up a UE in an RRC-connected state; a format for waking up a UE in an RRC-idle or inactive state.

In an implementation, the format of the data signal is determined in at least one of the following ways: being predefined; being preconfigured; being determined by a synchronization signal before the data signal; being indicated by the first data signal included in the wake up signal; being indicated by a data signal before the data signal.

In an implementation, wherein the first data signal of the multiple data signals uses a first format, and remaining data signals of the multiple data signals use a second format, wherein the first format is used to carry cell common wake up information, and the second format is used to carry wake up information for a specific UE or a specific UE group; or, the first format is used to carry common wake up information for a specific UE group, and the second format is used to carry wake up information for a specific UE or a specific UE subgroup in the specific UE group.

In an implementation, wherein the data signal includes multiple information blocks, each of the multiple information blocks is used to indicate wake up information for a UE or a UE group, and the number of the information blocks included in the data signal is determined in at least one of the following ways: being predefined; being pre-configured; being indicated by the first data signal included in the wake up signal; being indicated by a data signal before the data signal.

In an implementation, wherein the physical signal sequence used by the synchronization signal included in the wake up signal is generated based on a predefined or preconfigured parameter, or selected from multiple predefined physical signal sequences.

In an implementation, wherein the signal sequence used by the synchronization signal is generated based on a predefined or preconfigured parameter including at least one of: an identification ID of a cell; a cell-radio network temporary identifier (C-RNTI) value of the UE; a temporary mobile subscriber identity (TMSI) value of the UE; an identification ID of the UE; an index of a radio frame/slot/symbol where the synchronization signal is located.

In an implementation, wherein the signal sequence used by the synchronization signal is selected from multiple predefined physical signal sequences, including: the physical signal sequence used by the synchronization signal being configured by system information or UE-specific RRC signaling; or, the physical signal sequence used by the synchronization signal being determined by the UE through blind detection.

In an implementation, wherein the number of the information bits carried by the data signal is predefined, determined according to the synchronization signal in the wake up signal, or configured through system information or UE-specific RRC signaling.

In an implementation, wherein the wake up information includes at least one of: information for indicating whether the data signal is the last data signal in the wake up signal; information for indicating the number of the data signals included in the wake up signal; information for indicating the number of other data signals after the data signal; information for indicating formats of other data signals after the data signal; information for indicating the number of information blocks included in other data signals after the data signal; information for indicating an identification ID of the UE; information for indicating an identification ID of the UE group; information for indicating a C-RNTI of the UE; information for indicating a TMSI of the UE; information for indicating a duration of physical downlink control channel (PDCCH) monitoring to be performed by the UE; information for indicating a bandwidth part (BWP) where the PDCCH monitoring to be performed by the UE occurs; information for indicating a search space (SS) or a search space group (SSG) where the PDCCH monitoring to be performed by the UE occurs; information for indicating a value of a discontinuous reception (DRX) timer to be started by the UE; information for indicating a configuration index of a semi-persistent scheduling (SPS) physical downlink shared channel (PDSCH) to be received or skipped by the UE; information for indicating a sleep BWP related to at least one secondary cell of the UE; information for indicating base station time-domain energy saving; information for indicating base station frequency-domain energy saving; information for indicating base station space-domain energy saving; information for indicating network carrier-domain energy saving.

In an implementation, wherein a location of an information block or a location of a start information bit corresponding to the UE is configured through UE-specific RRC signaling or determined according to a C-NRTI or TMSI of the UE.

In an implementation, wherein the information block includes at least one of: information for indicating whether the UE or UE group is waked up; information for indicating a sleep BWP of one or more serving cells of the UE; information for indicating an identification ID of the UE; information for indicating an identification ID of the UE group; information for indicating a C-RNTI of the UE; information for indicating a TMSI of the UE; information for indicating a duration of PDCCH monitoring to be performed by the UE; information for indicating a BWP where the PDCCH monitoring to be performed by the UE occurs; information for indicating a search space (SS) or a search space group (SSG) where the PDCCH monitoring to be performed by the UE occurs; information for indicating a value of a DRX timer to be started by the UE; information for indicating a configuration index of an SPS-PDSCH to be received or skipped by the UE; information for indicating a sleep BWP related to at least one secondary cell of the UE.

The method according to the embodiment of the present disclosure further includes:
receiving the multiple data signals one by one, and skipping reception of subsequent data signals after receiving wake up information related to the UE; or
receiving the first data signal of the multiple data signals, determining whether there is a data signal that needs to be received in the subsequent data signals according to indication information in the first data signal, receiving the subsequent data signals one by one and skipping the reception of the subsequent data signals after receiving the wake up information related to the UE if there is the data signal that needs to be received, and skipping the reception of all subsequent data signals if there is no data signal that needs to be received; or
receiving the first data signal of the multiple data signals, determining whether there is the data signal that needs to be received in the subsequent data signals and determining a sequence index of the data signal that needs to be received according to the indication information in the first data signal, directly receiving the data signal corresponding to the sequence index if there is the data signal that needs to be received, and skipping the reception of all subsequent data signals if there is no data signal that needs to be received; or
receiving only one data signal of the multiple data signals, wherein a sequence index of the one data signal in the multiple data signals is configured through UE-specific RRC signaling or determined based on a C-RNTI or TMSI of the UE.

In an implementation, wherein the performing of the corresponding behavior includes at least one of: starting a discontinuous reception (DRX) onDuration timer drx-onDurationTimer at a start location of a next DRX cycle; starting physical downlink control channel (PDCCH) monitoring after a third interval from the wake up signal; starting the DRX onDuration timer or a first DRX timer after a fourth interval from the wake up signal, wherein the UE performs PDCCH monitoring during running of the first DRX timer; receiving a semi-persistent scheduling (SPS) PDSCH on a resource of a next SPS PDSCH; and entering an operating mode for a network non-energy-saving state after a fifth interval from the wake up signal.

In an implementation, wherein the third interval, the fourth interval or the fifth interval is predefined, preconfigured through higher layer signaling, reported by the UE, or indicated by the wake up signal.

In an implementation, wherein the duration of the PDCCH monitoring is predefined, preconfigured through higher layer signaling, or indicated by the wake up signal.

In an implementation, wherein the wake up signal including multiple data signals, further includes: a start time point of the PDCCH monitoring is after a third interval from the data signal corresponding to the UE or after the third interval from the last data signal of the wake up signal; and/or a start time point of the first DRX timer is after a fourth interval from the data signal corresponding to the UE or after the fourth interval from the last data signal of the wake up signal; a time point when entering the operating mode for the network non-energy-saving state is after a fifth interval from the last data signal of the wake up signal.

In an implementation, wherein the PDCCH monitoring is for all search spaces or a first search space, and wherein an index number of the first search space is predefined, preconfigured through higher layer signaling, or indicated by the wake up signal.

In an implementation, wherein a duration of the first DRX timer is the same as that of a DRX onDuration timer drx-onDurationTimer or a DRX inactivity timer drx-inactivity Timer, or is predefined or preconfigured.

In an implementation, wherein an index number of the SPS PDSCH is predefined, preconfigured through higher layer signaling, or indicated by the wake up signal.

In an implementation, wherein the UE monitoring the wake up signal includes at least one of: monitoring the wake up signal during a DRX inactive time; monitoring the wake up signal during skipping of a PDCCH; monitoring the wake up signal in a first time window related to each DRX cycle during the DRX inactive time, wherein a start location of the first time window is before a start location of a DRX cycle and separated by a first interval, and an end location of the first time window is before the start location of the DRX cycle and separated by a second interval or after the start location of the DRX cycle and separated by a sixth interval; monitoring the wake up signal in a second time window before each SPS PDSCH transmission occasion; monitoring the wake up signal in a network energy-saving state.

In an implementation, wherein the first interval is predefined or preconfigured through higher layer signaling, the second interval is predefined or reported by the UE, the sixth interval is predefined or preconfigured through higher layer signaling, and a start location and an end location of the second time window are predefined or pre-configured.

The method according to the embodiment of the present disclosure further includes skipping the monitoring of the wake up signal under a first condition and spontaneously performing a predetermined behavior at a preset time point, wherein the first condition includes at least one of: an amount of change of a measured reference signal received power (RSRP) within a preset period of time being greater than or equal to a first threshold; a value of the measured RSRP being smaller than or equal to a second threshold; a duration in which the wake up signal is not received being greater than or equal to a third threshold, wherein the RSRP is obtained by measuring at least one of a synchronization signal of the wake up signal, a synchronization signal/PBCH block (SSB), and a channel state information reference signal (CSI-RS) of the UE.

In an implementation, wherein the preset time point includes at least one of: a start location of a next DRX cycle; a time point preconfigured by a base station; a time point determined based on a time point when a primary communication receiver (PCR) of the UE enters a sleep mode last time; a time point determined based on an occurrence time of the first condition.

In an implementation, wherein whether there is a quasi co-location (QCL) relationship between the wake up signal and a synchronization signal/PBCH block (SSB) and/or a type of the QCL is preconfigured by a base station.

In an implementation, wherein the wake up signal includes wake up signals transmitted sequentially on multiple beams.

In an implementation, wherein: synchronization signals and data signals of the wake up signal are transmitted sequentially on the multiple beams together; or the synchronization signals of the wake up signal are transmitted sequentially in the multiple beam directions alone, and then the data signals of the wake up signal are transmitted sequentially on the multiple beams alone.

In an implementation, wherein the multiple beams have a one-to-one correspondence with beams corresponding to SSBs actually transmitted in an SSB burst set, or the multiple beams are a subset in a beam set corresponding to the SSBs actually transmitted in the SSB burst set.

According to an embodiment of the present disclosure, a method performed by a base station is provided, including: transmitting a wake up signal including at least one data signal to a user equipment (UE) to wake up the UE, wherein the data signal carries wake up information for at least one UE or at least one UE group, or common wake up information, and transmitting a downlink signal/channel to the UE or receiving an uplink signal/channel transmitted by the UE, after the UE is waked up based on the wake up signal.

According to an embodiment of the present disclosure, a communication device is provided, including: a transceiver configured to receive and/or transmit signals; and a controller coupled with the transceiver and configured to perform the methods according to one or more embodiments of the present disclosure.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for a method and apparatus for low power wake up technology.

### BRIEF DESCRIPTION OF DRAWINGS

FIG. 1 is an overall structure of a wireless network;

FIG. 2a is a transmission path and a reception path;

FIG. 2b is a transmission path and a reception path;

FIG. 3a is a structure diagrams of a UE and a base station, respectively;

FIG. 3b is a structure diagrams of a UE and a base station, respectively;

FIG. 4 is an example structure diagram of a low power wake up signal (LP-WUS);

FIG. 5 is an example structure diagram of an LP-WUS;

FIG. 6 is an example transmission pattern of an LP-WUS;

FIG. 7 is an example transmission pattern of an LP-WUS;

FIG. 8 is a schematic block diagram of a communication device according to an embodiment of the present disclosure.

### MODE FOR THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

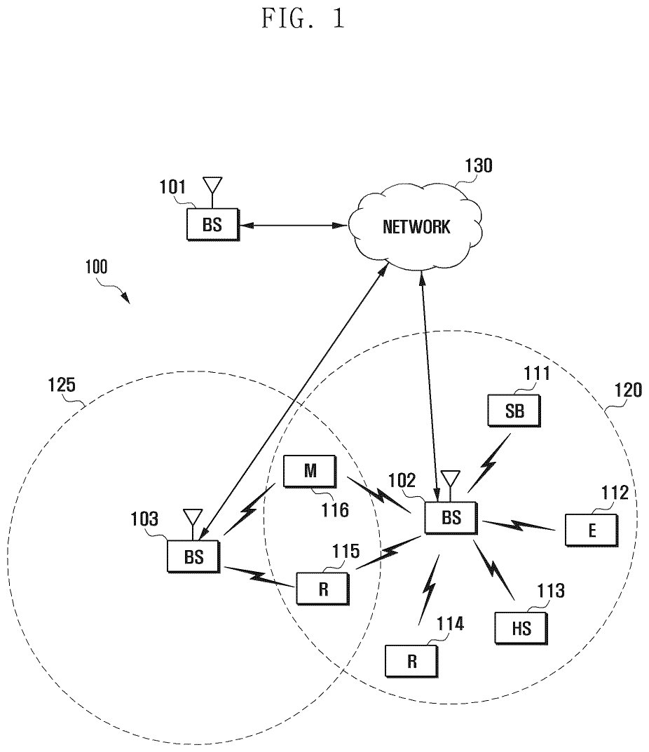

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can com-municate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

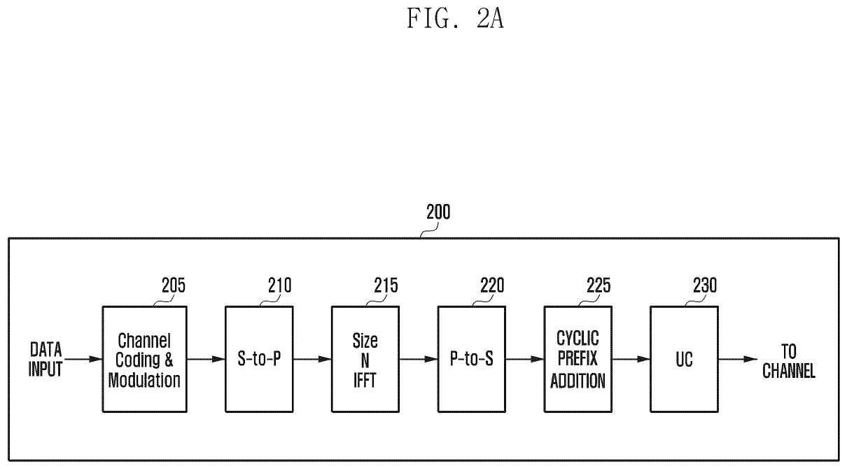

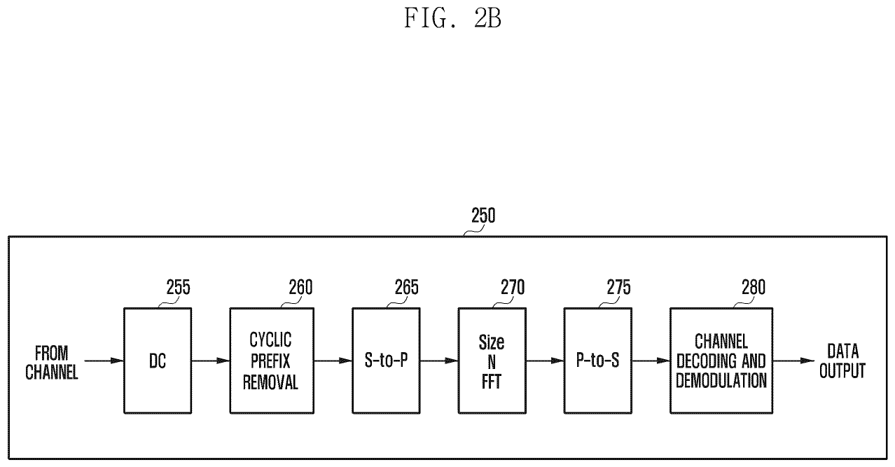

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

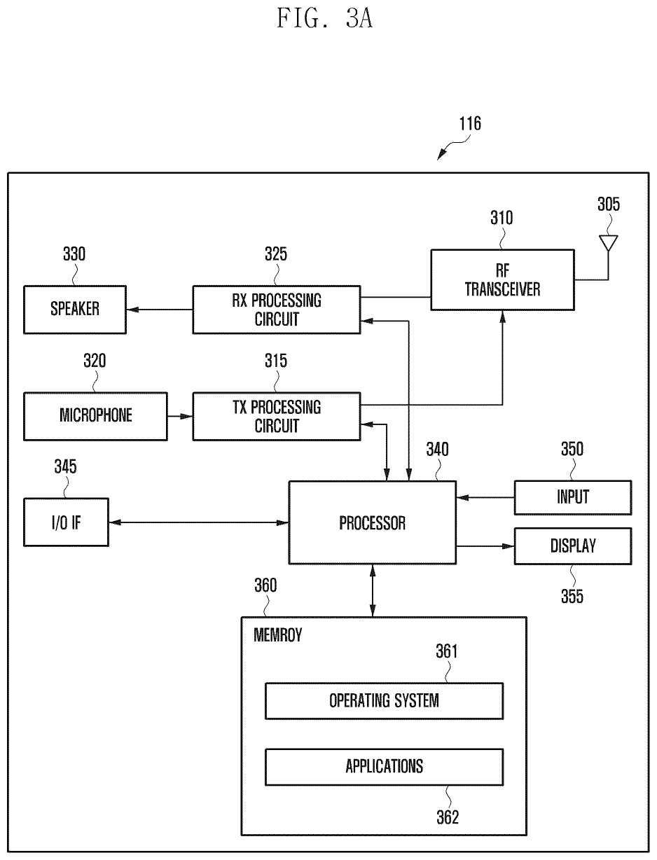

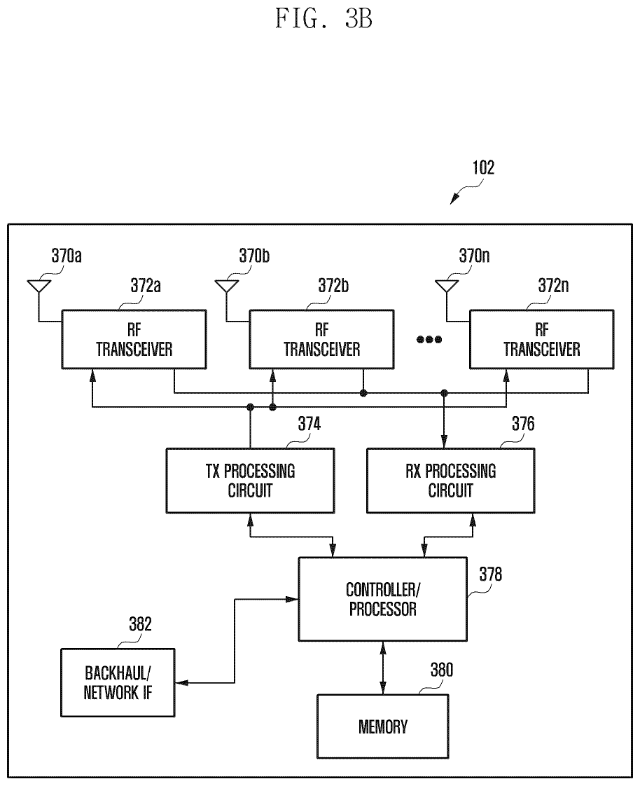

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/ controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/ controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/ controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370 a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/ processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The exemplary embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

The power-saving technology has always been an important design goal of communication systems, especially the power-saving technology at a UE side is the most important. In the 5G communication system, an important power-saving technology is the Discontinuous Reception (DRX) technology. In an RRC-idle state/inactive state, a receiver of the UE is in a sleep state for most of a DRX cycle, and only needs to wake up periodically to monitor a Paging Occasion (PO). In an RRC-connected state, each DRX cycle includes an active time and a non-active time. During the active time, the UE needs to monitor a PDCCH, while during the non-active time, the UE does not need to monitor the PDCCH. The UE starts a drx-onDurationTimer (DRX onDuration timer) at a start location of each DRX cycle to start monitoring the PDCCH. In a transmission process, if the UE monitors Downlink Control Information (DCI) scheduling new data transmission, then the UE starts a drx-inactivity Timer (DRX inactivity timer). During the DRX active time, a base station may indicate the UE to enter the DRX inactive time in advance by signaling, or when all DRX timers of the UE stop running, the UE may enter the DRX inactive time. Although the existing power-saving technology can effectively save the power consumption of the UE, the power-saving degree is far from enough for some terminals with high requirements on the battery life (such as an IOT UE and a RepCap UE). Herein, a related technical detail based on a wake up signal (e.g., a low power wake up signal (LP-WUS)) is given. It should be understood that although the LP-WUS is described as an example of the wake up signal in the following description, it is not intended to limit the wake up signal used in the present disclosure to the LP-WUS only, but the principles of the present disclosure may also be applied to other wake up signals or other signals.

### Function of LP-WUS

In order to save power, the receiver of the UE may include two modules, one is a Primary Communication Receiver (PCR), which is used to receive a conventional signal/channel transmitted by the base station, and the other is a low power wake up signal receiver (LP-WUR), which is used to receive the LP-WUS transmitted by the base station. The dedicated module is used to receive the LP-WUS because the LP-WUS is based on OOK modulation, which is different from a waveform based on OFDM or SC-FDMA in the NR system. The receiver can detect the OOK-modulated signal based on energy monitoring, so that the LP-WUR can monitor the LP-WUS with extremely low power. If the LP-WUR monitors the LP-WUS, the LP-WUR may trigger the PCR to transition from sleep period to active period, and the PCR may perform a predetermined behavior after being activated.

In an embodiment, the UE in the RRC-connected state receives configuration information for the LP-WUS, and monitors the LP-WUS through the LP-WUR based on the configuration information. The LP-WUS may carry information for waking up at least one UE respectively, and/or the LP-WUS may carry information for waking up at least one UE group respectively, and/or the LP-WUS may carry common wake up information. If the LP-WUR monitors the LP-WUS and the UE is waked up according to an indication of the LP-WUS, the LP-WUR may trigger the activation of the PCR. After the PCR is activated, one of the following UE behaviors may be performed:
the UE starts a DRX onDuration timer drx-onDurationTimer at a start location of a next DRX cycle;
the UE starts PDCCH monitoring after a third interval from the LP-WUS;
the UE starts a first DRX timer after a fourth interval from the LP-WUS, for example, the first DRX timer may be a DRX onDuration timer drx-onDurationTimer or a DRX inactivity timer drx-inactivityTimer, or a newly defined DRX timer using a dedicated configuration parameter;
the UE receives or skips an SPS-PDSCH on resources of a next semi-persistent scheduling PDSCH (SPS PDSCH);
the UE switches from an operating mode for a base station energy-saving state to an operating mode for a base station non-energy-saving state after a fifth interval from the LP-WUS.

Alternatively, the behavior of the UE after being waked up by the LP-WUS is predefined, for example, the predefined behavior may be any of the above UE behaviors. For example, the system may configure one LP-WUS for one of the above UE behaviors, that is, the UE only monitors one LP-WUS configuration, and if the UE is waked up by the LP-WUS, the predefined UE behavior is performed; or, the system may configure corresponding LP-WUSs for the above multiple UE behaviors respectively, that is, the UE monitors multiple LP-WUS configurations, and if the UE is waked up by one LP-WUS, the corresponding predetermined behavior is performed.

Alternatively, the behavior of the UE after being waked up by the LP-WUS is configurable, that is, one LP-WUS configuration may wake up the UE to perform one of multiple predetermined behaviors, and which UE behavior the UE performs after being waked up by the LP-WUS may be preconfigured through higher layer signaling, such as system information or UE-specific RRC signaling; or, which UE behavior the UE performs after being waked up by the LP-WUS may be indicated by information carried by the LP-WUS.

In an alternative, the base station wakes up the UE through the LP-WUS to start the drx-onDuration Timer at the start location of the next DRX cycle. For example, the UE may monitor the LP-WUS during the DRX non-active time, and it is not necessary to monitor the LP-WUS during the DRX active time. If the UE monitors the LP-WUS, the UE may start the drx-onDuration Timer at the start location of the next DRX cycle. For example, the UE may monitor the LP-WUS in a time window (which may also be referred to as a monitoring window) before a start location of each DRX cycle. If the UE monitors the LP-WUS at a time point in the monitoring window, the LP-WUS monitoring is skipped at subsequent time in the monitoring window. A location of the LP-WUS monitoring window may be determined according to the start location of the DRX cycle. For example, a start location of the LP-WUS monitoring window may be a location separated by a first interval before the start location of the DRX cycle. The first interval may be predefined or preconfigured through higher layer signaling. An end location of the LP-WUS monitoring window may be a location separated by a second interval before the start location of the DRX cycle. The second interval may be predefined or reported by the UE. For example, a value of the second interval may be related to a shortest processing time that the UE wakes up after receiving the wake up signal and is prepared to start the drx-onDurationTimer at the start location of the next DRX cycle.

In yet another alternative, the base station wakes up the UE through the LP-WUS to start the PDCCH monitoring after a third interval from the LP-WUS. For example, the UE may monitor the LP-WUS during PDCCH skipping or the DRX inactive time, and does not need to monitor the LP-WUS during other time. If the LP-WUS is monitored, then the UE may start the PDCCH monitoring at a location separated by the third interval after the LP-WUS, for example, the PDCCH monitoring is started at the first slot or the first symbol that meets the third interval after the LP-WUS. The third interval may be predefined, preconfigured through higher layer signaling, reported by the UE, or indicated by the LP-WUS. Here, the PDCCH monitoring started by the UE may be PDCCH monitoring on all search spaces or PDCCH monitoring on partial search spaces. For example, the PCR may only monitor the PDCCH on a specific search space after being waked up, and an index number of the specific search space may be predefined, preconfigured through higher layer signaling, or indicated by the LP-WUS. In addition, the duration in which the UE starts the PDCCH monitoring may be predefined, preconfigured through higher layer signaling, or indicated by the LP-WUS.

In yet another alternative, the base station wakes up the UE through the LP-WUS to start the DRX timer after a fourth interval from the LP-WUS, the DRX timer may be the existing onDuration timer drx-onDuration Timer or inactivity timer drx-inactivity Timer. In a case that the UE starts the drx-onDuration Timer after being waked up, it indicates that the location where the DRX onDuration timer is started may not be limited to the start location of the DRX cycle. For example, the UE may start the drx-onDuration Timer at any location during the DRX inactive time based on the indication of the LP-WUS, or the UE may start the drx-onDuration Timer at any location in a time window of the DRX cycle based on the indication of the LP-WUS.

In a case that the UE starts the drx-inactivity Timer after being waked up, it indicates that a condition for starting the drx-inactivity Timer may not be limited to receiving new data scheduling. For example, the UE may start the drx-inactivityTimer at any location during the DRX inactive time based on the indication of the LP-WUS. In addition, the DRX timer may also be a newly defined DRX timer, which is similar to the drx-onDuration Timer and the drx-inactivity Timer. As long as the newly defined DRX timer is running, the UE needs to monitor the PDCCH, and a duration of the newly defined DRX timer may be specifically configured. For example, the UE may monitor the LP-WUS during the DRX inactive time, and does not need to monitor the LP-WUS during other time. If the UE R monitors the LP-WUS, the UE may start the DRX timer at a location separated by a fourth interval after the LP-WUS, for example, the DRX timer is started at the first slot that meets the fourth interval after the LP-WUS. The fourth interval may be predefined, preconfigured through higher layer signaling, reported by the UE, or indicated by the LP-WUS. Here, a value (i.e., length of duration) of the DRX timer started by the UE may be predefined, preconfigured through higher layer signaling, or indicated by the LP-WUS, or the configuration of the existing drx-onDuration Timer or drx-inactivity Timer may be reused.

Alternatively, the UE monitors the LP-WUS within a time window (which may also be referred to as a monitoring window). If the UE monitors the LP-WUS at a time point in the monitoring window, the LP-WUS monitoring is skipped at subsequent time in the monitoring window. A location of the LP-WUS monitoring window may be determined according to the start location of the DRX cycle. For example, a start location of the LP-WUS monitoring window may be a location separated by a first interval before the start location of the DRX cycle. The first interval may be predefined or preconfigured through higher layer signaling. An end location of the LP-WUS monitoring window may be a location separated by a sixth interval after the start location of the DRX cycle. The sixth interval may be predefined or preconfigured through higher layer signaling. If the UE monitors the LP-WUS, and the LP-WUS includes wake up information for the UE, then the UE starts the drx-onDurationTimer. The location where the UE starts the drx-onDuration Timer is the first slot that meets the fourth interval after the LP-WUS and is located in the next DRX cycle. That is, the earliest location where UE starts the drx-onDurationTimer is the start location of the next DRX cycle, and the UE may also start the drx-onDurationTimer after the start location of the next DRX cycle. In other words, the base station may wake up the UE through the LP-WUS to start the drx-onDurationTimer at any location in a time window of the DRX cycle, the time window is located in the first part of the DRX cycle, and a start location of the time window is the start location of the DRX cycle.

In yet another alternative, the base station indicates, through the LP-WUS, the UE to receive or skip a Semi-Persistent Scheduling (SPS) PDSCH. For example, the UE may monitor the LP-WUS in a time window before each SPS-PDSCH transmission occasion, and a start location and/or end location of the time window may be determined based on a time-domain location of the SPS-PDSCH. The LP-WUS indicates whether the UE receives the PDSCH on the corresponding SPS-PDSCH transmission occasion, and a configuration index number of the SPS-PDSCH may be predefined, preconfigured through higher layer signaling, or indicated by the LP-WUS.

In another alternative, the base station indicates, through the LP-WUS, the UE to switch from the operating mode for the base station energy-saving state to the operating mode for the base station non-energy-saving state after the fifth interval from the LP-WUS, in other words, the base station will switch from the base station energy-saving state to the base station non-energy-saving state after the fifth interval from the LP-WUS. For example, assuming that the base station switches from an OFF state for time-domain energy saving to an ON state, the base station may wake up the UE through the LP-WUS to switch from an operating mode for the base station OFF state to an operating mode for the base station ON state. The OFF state means that the base station does not provide data services for any UE in order to save energy, and the base station switches off the transmission of most channels/signals, leaving only the transmission of a few necessary channels/signals. The ON state means that the base station can provide normal data services for the UE and can transmit and receive all channels/signals normally. In addition, the LP-WUS may also indicate frequency-domain energy-saving information of the base station, space-domain energy-saving information of the base station, and/or carrier energy-saving information of the network. For example, the frequency-domain energy-saving information of the base station includes information indicating an actual transmission bandwidth at the base station side, and the UE only needs to receive information within the actual transmission bandwidth. The space-domain energy-saving information of the base station includes information indicating whether each of multiple beams is switched off. If one beam is switched off, the UE does not need to receive a channel/signal in a corresponding beam direction, and if one beam is switched on, the UE may receive the channel/signal in the corresponding beam direction. The carrier energy-saving information of the network includes information indicating whether a certain carrier of multiple carriers is activated. If an carrier is deactivated, the UE cannot receive or transmit a signal on a serving cell of the corresponding carrier, and if an carrier is activated, the UE may receive or transmit a signal on the serving cell of the corresponding carrier.

### Constitution and Transmission of LP-WUS

In an embodiment, the LP-WUS based on OOK modulation may mainly include two parts of a signal. The first part of the signal is called a synchronization signal (which is called a WUS-SYNC for short) for the UE to acquire downlink synchronization. In addition, the WUS-SYNC may also be used to determine that the second part of the signal is transmitted, that is, the UE only receives the corresponding second part of the signal after monitoring the first part of the signal. The second part of the signal is called a data signal (which is called a WUS-Data for short) for carrying related information bits for waking up the UE. For example, the WUS-Data is used to carry information for waking up a UE, information for waking up a group of UEs, and/or common wake up information. The WUS-Data may wake up a UE or wake up multiple UEs respectively, or the WUS-Data may wake up a group of UEs or wake up multiple groups of UEs respectively, or the WUS-Data wakes up all UEs that monitor the WUS-Data. The WUS-SYNC provides basic synchronization for the reception of the WUS-Data, so the WUS-Data can immediately follow the WUS-SYNC.

In an alternative, the synchronization signal and data signal of the LP-WUS always occur together, that is, after each WUS-SYNC, there is a corresponding WUS-Data, and the UE periodically monitors the LP-WUS. At an LP-WUS transmission occasion, the LP-WUS may or may not be monitored by the UE. In another alternative, the synchronization signal and data signal of the LP-WUS do not occur together, that is, not every WUS-SYNC is followed by a corresponding WUS-Data. For example, the synchronization signal of the LP-WUS is transmitted periodically for the UE to maintain synchronization and perform some necessary measurements, but only some synchronization signals are followed by a corresponding WUS-Data for waking up the UE or UE group. The UE periodically monitors the LP-WUS, and the UE may receive the WUS-SYNC at every LP-WUS transmission occasion, but the WUS-Data may or may not be monitored by the UE.

In another embodiment, the LP-WUS only includes the WUS-SYNC, and the WUS-SYNC may implicitly indicate related information for waking up the UE through a signal sequence used. In yet another embodiment, the LP-WUS only includes the WUS-Data, and the UE acquires downlink synchronization based on other periodic signals, and periodically monitors the WUS-Data while maintaining synchronization. In the following description, for the sake of simplicity, an example in which the LP-WUS includes the WUS-SYNC and the WUS-Data and the WUS-Data always follows the WUS-SYNC will be mainly described. It should be understood that this is only exemplary, and the principles of the present disclosure may also be applied to other structures of the LP-WUS.

The WUS-SYNC is essentially an OOK-modulated physical signal sequence. At the base station side, a predefined physical signal sequence is transmitted after OOK modulation, and at the UE side, whether the WUS-SYNC is transmitted or not is monitored based on the predefined physical signal sequence.

Alternatively, the WUS-SYNC selects one from multiple predefined physical signal sequences, and which of the multiple predefined physical signal sequences is used by the WUS-SYNC may be preconfigured, for example, configured through system information or UE-specific RRC signaling.

Alternatively, which of the multiple predefined physical signal sequences is used by the WUS-SYNC is uncertain, and the UE determines which physical signal sequence is used by the WUS-SYNC through blind detection. Here, the WUS-SYNC may implicitly carry some information through the used physical signal sequence, for example, the WUS-SYNC may implicitly carry a format of the WUS-Data through the used physical signal sequence.

In addition, the physical signal sequence used by the WUS-SYNC may be generated based on predefined or preconfigured parameters, for example, the physical signal sequence may be generated based on at least one of a cell physical ID, a UE ID, a C-RNTI value of the UE, a TMSI value of the UE, and an index of a radio frame/ slot/symbol where the WUS-SYNC is located.

The WUS-Data is essentially an OOK-modulated data bitstream. At the base station side, the related information bits for UE wake up are encoded and then transmitted after OOK modulation. At the UE side, the WUS-Data is decoded based on the synchronization obtained by the WUS-SYNC. The number of information bits of the WUS-Data may be predefined. For example, the number of the information bits of the WUS-Data is fixed to a predefined value. Alternatively, the number of the information bits of the WUS-Data is selected from multiple predefined values, and which one of them is used for the number of the information bits of the WUS-Data is preconfigured, for example, configured through system information or UE-specific RRC signaling, or implicitly indicated by the WUS-SYNC before the WUS-Data.

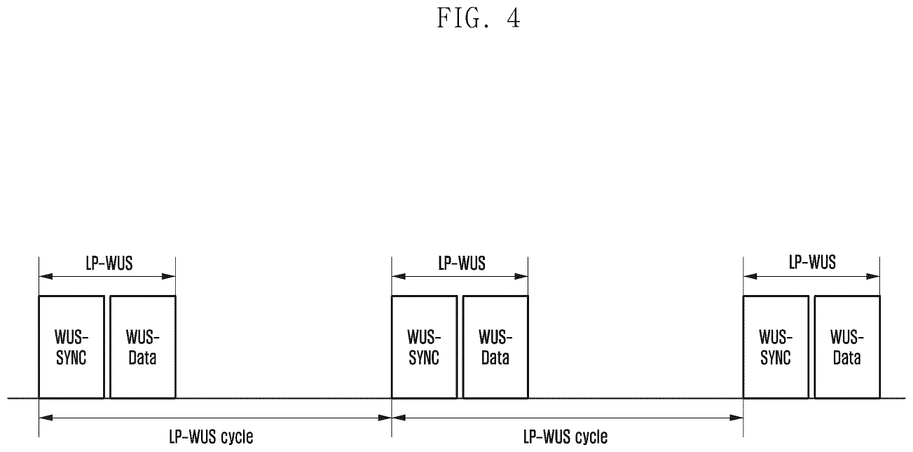

In an alternative, the WUS-SYNC is followed by a WUS-Data, as shown in FIG. 4, that is, the LP-WUS includes a WUS-SYNC and a WUS-Data.

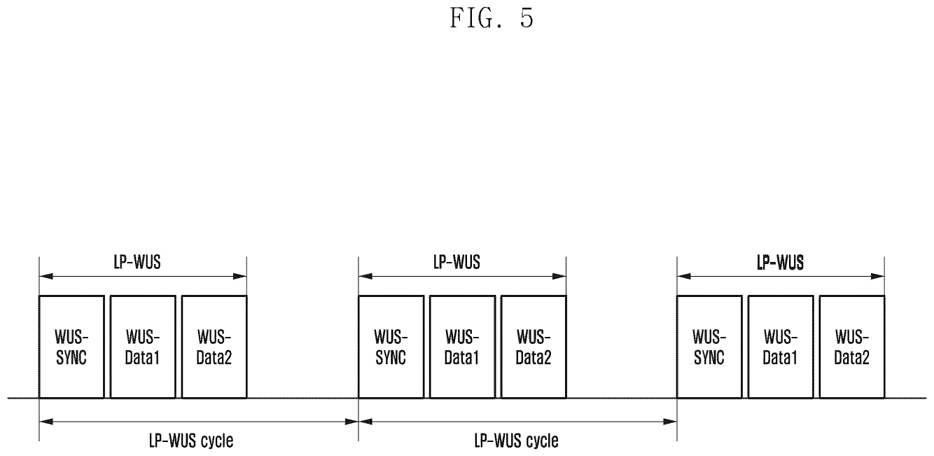

In another alternative, as shown in FIG. 5, the WUS-SYNC may be followed by multiple WUS-Datas, which are encoded and modulated respectively, that is, the LP-WUS includes a WUS-SYNC and multiple WUS-Datas.

In an implementation, the LP-WUS includes a WUS-SYNC and N WUS-Datas, where N is a positive integer predefined or preconfigured through higher layer signaling. Alternatively, the LP-WUS includes a WUS-SYNC and a variable number (within a certain number range) of WUS-Datas. For example, the number of WUS-Datas included in the LP-WUS may vary between 1 to N, where N is a positive integer greater than 1 that is predefined or preconfigured through higher layer signaling, and the number of WUS-Datas may be determined by the UE through blind detection, or, the number of WUS-Datas may be determined by the physical signal sequence used by the WUS-SYNC, or the number of WUS-Datas may be indicated by the first WUS-Data thereof, or each WUS-Data included in the LP-WUS indicates the number of subsequent WUS-Datas, or each WUS-Data included in the LP-WUS indicates whether the WUS-Data is the last WUS-Data.

Alternatively, the LP-WUS includes multiple WUS-Datas, which may carry the same information bits, that is, multiple WUS-Datas may be regarded as repeated transmissions of a WUS-Data; or, the multiple WUS-Datas carry different information bits, for example, the multiple WUS-Datas are used to wake up different UEs or different UE groups, respectively.

In an alternative, the standard may define multiple formats for the information content carried by the WUS-Data, the formats specify the content of indication fields carried by the WUS-Data, and different WUS-Data formats are used to carry information bits of different contents for different wake up functions. For example, there may be a WUS-Data format dedicated to waking up the UE in the RRC-idle state or inactive state. There may be a WUS-Data format dedicated to waking up the UE in the RRC-connected state, a WUS-Data format dedicated to carrying cell common wake up information, and a WUS-Data format dedicated to carrying wake up information for a specific UE or a specific UE group. Each WUS-Data format includes at least one indication field, and the number of bits included in each indication field may be predefined or preconfigured. According to the format used by the WUS-Data, the UE may determine the content of the indication field included, in other words, the number of information bits included.

Alternatively, the format used by the WUS-Data is implicitly indicated by the physical signal sequence used by the WUS-SYNC before the WUS-Data. For example, UE determines the physical signal sequence used by the WUS-SYNC through blind detection, and determines the WUS-Data format corresponding to the WUS-SYNC according to the determined physical signal sequence.

Alternatively, the LP-WUS includes multiple WUS-Datas, which use the same format. For example, a WUS-Data may wake up one or M UEs, and the base station may wake up N or N*M UEs through N WUS-Datas included in the LP-WUS.

Alternatively, the LP-WUS includes multiple WUS-Datas, which use different formats, for example, the first WUS-Data of the multiple WUS-Datas uses a first format, and the rest WUS-Datas of the multiple WUS-Datas use a second format, where the first format is used to carry the cell common wake up information, and the second format is used to carry the wake up information for a certain UE or a certain UE group; or, the first format is used to carry common wake up information for a UE group, and the second format is used to carry the wake up information for a certain UE or a certain UE subgroup in the UE group.

Alternatively, the LP-WUS includes multiple WUS-Datas, a format of the first WUS-Data of which is predefined, and the first WUS-Data may indicate formats of subsequent WUS-Datas; or, the previous WUS-Data may indicate a format of the next WUS-Data.

In an alternative, the WUS-Data may wake up a UE or a group of UEs; or, the WUS-Data may wake up multiple UEs or multiple groups of UEs respectively, that is, the WUS-Data includes multiple information blocks, each information block is used to wake up a UE or a group of UEs, and specifically, the WUS-Data includes M information blocks, or the WUS-Data includes 1 to M information blocks, where M is a positive integer greater than 1 that is predefined or preconfigured. In a case that the LP-WUS includes multiple WUS-datas, the number of information blocks included in the first WUS-Data may be predefined or preconfigured through higher layer signaling, and the number of information blocks included in the rest WUS-Datas may be indicated by the first WUS-Data, or the previous WUS-Data indicates the number of information blocks included in the next WUS-Data.

Alternatively, the LP-WUS includes multiple WUS-Datas, and the UE may receive the WUS-Data one by one. If the UE is waked up by a WUS-Data, the UE may skip subsequent WUS-Datas, otherwise, the UE should continue to receive the subsequent WUS-Datas.

Alternatively, the LP-WUS includes multiple WUS-Datas. The UE first receives the first WUS-Data thereof, and determines whether there is a WUS-Data that the UE needs to receive in the subsequent WUS-Datas according to indication information in the first WUS-Data. If there is the WUS-Data that the UE needs to receive in the subsequent WUS-Datas, the UE receives the remaining WUS-Datas one by one until the UE is waked up by a WUS-Data or the UE receives all the WUS-Datas. If there is no WUS-Data that the UE needs to receive in the subsequent WUS-Datas, the UE directly skips all the remaining WUS-Datas.

Alternatively, the LP-WUS includes multiple WUS-Datas. The UE first receives the first WUS-Data thereof, and determines whether there is a WUS-Data that the UE needs to receive in the subsequent WUS-Datas according to indication information in the first WUS-Data. If there is the WUS-Data that the UE needs to receive in the subsequent WUS-Datas, the UE further determines a sequence index of the WUS-Data that needs to be received according to the indication information in the first WUS-Data, and directly receives the WUS-Data of the corresponding sequence index. If there is no WUS-Data that the UE needs to receive in the subsequent WUS-Datas, the UE directly skips all the remaining WUS-Datas. For example, the first WUS-Data of the LP-WUS indicates that multiple UE groups are waked up respectively, and further indicates which UE or UEs in the corresponding UE group are waked up in the multiple subsequent WUS-Datas, respectively.

Alternatively, the LP-WUS includes multiple WUS-Datas, and the UE only receives a WUS-Data among them. The sequence index of the WUS-Data received by the UE among the multiple WUS-Datas may be preconfigured through higher layer signaling, determined according to the C-RNTI of the UE, or determined according to the TMSI of the UE.

In the foregoing description, the main function of the LP-WUS is to wake up the UE to perform a predetermined behavior at a location at a preset interval after the LP-WUS, such as starting the PDCCH monitoring or starting the first DRX timer.

Assuming that the LP-WUS includes multiple WUS-Datas, an alternative is that the UE performs the predetermined behavior at a location at a preset interval after a WUS-Data where the UE wake up information is located, and another alternative is that the UE performs the predetermined behavior at a location at a preset interval after all the WUS-Datas of the LP-WUS.

In an alternative, information bits of the WUS-Data include multiple information blocks, each information block corresponding to different UEs or UE groups, and each information block includes the same number of bits. The UE only needs to receive the information block for it, in other words, information bits of a WUS-Data include information bits for multiple UEs or UE groups. Alternatively, the base station indicates a location of the information bit for the UE in the information bits of the WUS-Data through higher layer signaling, for example, the base station indicates to the UE which bit of the WUS-Data is a start information bit of the UE. Alternatively, the base station indicates the number of an information block for the UE in multiple information blocks through higher layer signaling, for example, the base station indicates to the UE which information block is the information block for the UE, and the UE determines a location of its own information bit in the information bits of the WUS-Data according to the number and size of the information block. Each information block may include at least one of the following indication fields:
a field for indicating whether the UE is waked up, such as a 1-bit indication field. If the indication value is “1”, the corresponding UE is waked up, and if the indication value is “0”, the corresponding UE is not waked up;
a field for indicating dormant information on at least one secondary cell of the UE, the dormant information may indicate whether an active BWP on the secondary cell is a dormant BWP.
a field for indicating a duration in which the UE performs the PDCCH monitoring;
a field for indicating a BWP where the UE performs the PDCCH monitoring;
a field for indicating a search space SS or a search space group SSG where the UE performs the PDCCH monitoring;
a field for indicating a value of a DRX onDuration timer or a first DRX timer started by the UE;
a field for indicating a configuration index of an SPS-PDSCH received or skipped by the UE;

Considering the reception processing delay of the WUS-SYNC by the UE, an interval may be reserved between the WUS-SYNC and the WUS-Data, which should meet the maximum reception processing delay of the WUS-SYNC supported by the UE, and the interval between the WUS-SYNC and the WUS-Data may be predefined, preconfigured through higher layer signaling, or reported by the UE; and/or, the interval between the WUS-SYNC and the WUS-Data should meet the requirement of an minimum interval, which may be predefined or reported by the UE. In addition, in a case that the LP-WUS includes multiple WUS-Datas, considering the reception processing delay of a WUS-Data by the UE, an interval may be reserved between two adjacent WUS-Datas, which should meet the maximum reception processing delay of a WUS-Data supported by the UE, and the interval between two adjacent WUS-Datas may be predefined, preconfigured through higher layer signaling, or reported by the UE; and/or, the interval between two adjacent WUS-Datas should meet the requirement of an minimum interval, which may be predefined or reported by the UE.

In an alternative, the information bits of the WUS-Data may include multiple indication fields, for example, at least one of the following indication fields:
a field for indicating whether the WUS-Data is the last WUS-Data of the current LP-WUS. In other words, the indication field implicitly indicates whether there are other WUS-Datas after the WUS-data;
a field for indicating the number of other WUS-Datas after the WUS-Data, or a field for indicating the number of WUS-Datas included in the current LP-WUS;
a field for indicating formats of other WUS-Datas after the WUS-Data;
a field for indicating the number of information blocks included in other WUS-Datas after the WUS-Data, where one information block is used to wake up a UE or a UE group;
a field for indicating an ID of a UE waked up, where the UE ID may be pre-configured through higher layer signaling, determined based on the C-RNTI of the UE, determined based on the TMSI of the UE, and if an ID of a UE is indicated by this field, it indicates that the UE is waked up;
a field for indicating a C-RNTI value of the UE waked up, where if a C-RNTI value of a UE is indicated by this field, it indicates that the UE is waked up;
a field for indicating a TMSI value of the UE waked up, where if a TMSI value of a UE is indicated by this field, it indicates that the UE is waked up;
a field for indicating an ID of a UE group waked up, where the UE group ID may be preconfigured through higher layer signaling, determined based on the C-RNTI of the UE, or determined based on the TMSI of the UE, and if an ID of a UE group is indicated by this field, it indicates that all UEs in this UE group are waked up;
a field for indicating a duration in which the UE waked up performs the PDCCH monitoring;
a field for indicating a BWP where the UE waked up performs the PDCCH monitoring;
a field for indicating a search space SS or a search space group SSG where the UE waked up performs the PDCCH monitoring;
a field for indicating a value of a DRX onDuration timer or a first DRX timer started by the UE waked up;
a field for indicating a configuration index of an SPS-PDSCH received by the UE waked up;
a field for indicating time-domain energy-saving information of the base station, for example, for indicating that the base station is in an ON state or an OFF state for time-domain energy saving, and alternatively, for indicating a duration in which the base station will be in a corresponding time-domain energy-saving state;
a field for indicating frequency-domain energy-saving information of the base station, for example, for indicating a scaling factor of an actual transmission bandwidth of the base station relative to a reference bandwidth;
a field for indicating space-domain energy-saving information of the base station, for example, for indicating whether each of multiple beams is switched on or off;
a field for indicating carrier energy-saving information of the network, for example, for indicating whether each of multiple carriers is activated.

For the above indication fields included in the information blocks or WUS-Datas, multiple indication fields may be integrated into one indication field, that is, the integrated indication field is used to indicate the above multiple information, that is, the above multiple indication fields may be jointly indicated through one indication field. In addition, whether the indication fields are included and the number of bits of the indication fields may be preconfigured through higher layer signaling.

### Fallback Mechanism of LP-WUS

Because the LP-WUS is based on OOK modulation, the LP-WUS monitoring may be realized based on extremely low power consumption. However, a disadvantage of the OOK modulation is that the coverage performance of the LP-WUS is not as good as that of traditional signals/channels in the NR system, that is, an operating SNR point of the LP-WUS is high, and the probability of missing detection of the LP-WUS by the UE at a cell edge in the existing cell coverage of the NR system is high. In addition, when the downlink quality of the UE varies greatly, the UE may also miss the detection of the LP-WUS. If the LP-WUS is not detected by the UE for a long time, the actual situation may not be that the base station does not transmit the LP-WUS, but that the UE misses the detection of the LP-WUS, which causes the base station to be unable to wake up the UE to receive downlink data in time and has a great impact on the user experience. Therefore, it is necessary to specify the fallback mechanism of the LP-WUS.

In an embodiment, when a specific condition or event is satisfied, the UE skips the LP-WUS monitoring, or continues to monitor the LP-WUS but ignores the monitoring result of the LP-WUS, and the UE spontaneously performs a predetermined behavior, including starting the PDCCH monitoring, starting the DRX onDuration timer, starting the first DRX timer, receiving the SPS-PDCCH, switching to the operating mode for the base station non-energy-saving state or the like described above. For example, the UE may spontaneously perform the predetermined behavior when at least one of the following conditions or events is met:
if the LP-WUS is not detected by the UE within a preset time range (for example, a duration in which the UE doesn't detect the LP-WUS reaches a certain threshold), the UE skips the LP-WUS monitoring and spontaneously performs the predetermined behavior at a preset time point. “the UE doesn't detect the LP-WUS” means that the WUS-SYNC of the LP-WUS is not detected, or the WUS-Data of the LP-WUS is not detected (the WUS-SYNC may be detected), and the preset time range or the certain threshold may be predefined or preconfigured.
if an amount of change of an RSRP value measured by the UE in a period of time exceeds a first preset threshold, or if the RSRP value measured by the UE is lower than a second preset threshold, the UE spontaneously performs the predetermined behavior. The RSRP may be obtained based on SSB measurement, or based on WUS-SYNC measurement, or based on channel state information reference signal CSI-RS measurement, and the first preset threshold and the second preset threshold may be predefined or preconfigured.

In an alternative, when the above specific conditions or events are met, the UE spontaneously performs the predetermined behavior at a preset time point, which may be at least one of:
the preset time point being a start point of a next DRX cycle, for example, the UE spontaneously starts the drx-onDurationTimer at the start point of the next DRX cycle;
the preset time point being preconfigured by the base station, for example, the preset time point is periodic, and the UE spontaneously performs the predetermined behavior at a latest preset time point after the above specific conditions or events are met;
the preset time point being determined according to a time point when the PCR enters a sleep mode last time, for example, assuming that the PCR of the UE enters the sleep mode last time at a time point n, the UE spontaneously performs the predetermined behavior after a preset interval from the time point n, where a value of the preset interval may be predefined or preconfigured;
the preset time point being determined according to an occurrence time of the specific condition or event, for example, the UE spontaneously performs the predetermined behavior at a time point after a preset interval from the occurrence time of the specific condition or event, where a value of the preset interval may be predefined or preconfigured;

In an alternative, the UE activates the PCR after being waked up by the LP-WUS, or the UE spontaneously activates the PCR when the above specific conditions or events are met. If the predetermined behavior performed by the UE after activating the PCR is the starting of the PDCCH monitoring, and DCI scheduling new data for the UE is not detected by the UE within a preset period of time, the UE may stop the PDCCH monitoring, set the PCR to switch to the sleep mode, and monitor the LP-WUS through the WUR, where a length of the preset period of time may be predefined or pre-configured.

### Beam Sweeping of LP-WUS

In an embodiment, in order to ensure the coverage of the LP-WUS in high frequency network, similar to other signals/channels in the NR system, the LP-WUS may also improve the coverage by transmitting in different analog beam directions. If the LP-WUS is designed to be UE-specific, the WUS-SYNC and the WUS-Data may be transmitted based on a best downlink beam for the UE. If the LP-WUS is designed to be cell-specific or UE group-specific, the WUS-SYNC and the WUS-Data may be transmitted based on beam sweeping, and there is beam correspondence between the WUS-SYNC and the WUS-Data. For example, both the WUS-SYNC and the WUS-Data are transmitted sequentially in N beam directions, where a value of N will be described later, and N beams for transmitting the WUS-SYNC are the same as or correspond to N beams for transmitting the WUS-Data respectively, that is, they have a characteristic of Quasi Co-Location (QCL).

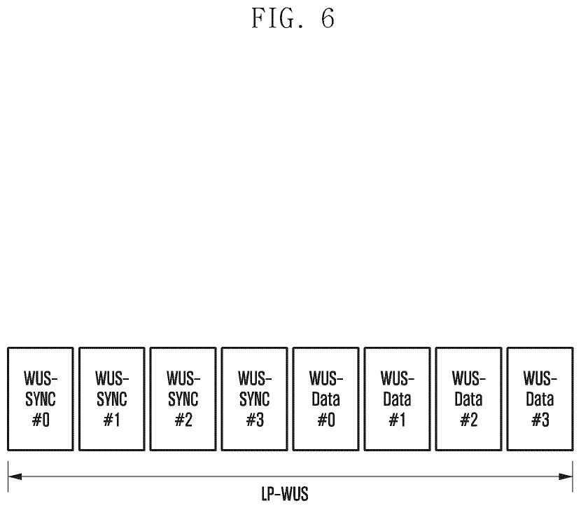

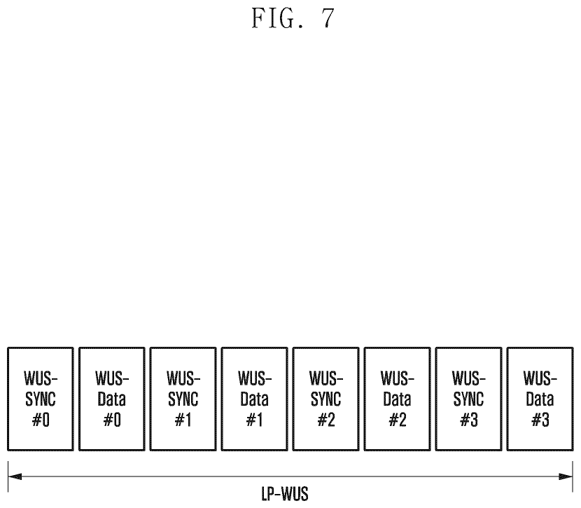

In a case that the LP-WUS is transmitted based on beam sweeping, an LP-WUS transmission occasion may use any of the following patterns:
as shown in FIG. 6, the WUS-SYNCs are transmitted sequentially in N beam directions, and the WUS-Datas are transmitted after the transmissions of the WUS-SYNCs in all the N beam directions are completed. The WUS-Datas are also transmitted sequentially in these N beam directions. The advantage of this design is that the UE can determine the best downlink beam direction based on the measurement of the WUS-SYNC, and then directly receive the WUS-Data in the corresponding beam direction, without receiving the WUS-Datas in different beam directions one by one, so as to achieve the purpose of saving UE power consumption.
as shown in FIG. 7, the WUS-SYNC in each beam direction is followed by the WUS-Data in the same beam direction. After the WUS-SYNC and the WUS-Data of the LP-WUS in one beam direction are transmitted, an LP-WUS in a next beam direction is transmitted until the LP-WUSs in N beam directions are transmitted sequentially. The advantage of this design is that if the best downlink beam of the UE is one at an earlier location among the N beams, the UE can receive the WUS-Data earlier in time, and it is not necessary to receive the WUS-Data after the WUS-SYNCs in all beam directions are transmitted as shown in FIG. 6, so as to reduce the wake up delay of the UE.

In an alternative, the beams used for the LP-WUS transmission are associated with the beams used for SSB transmission, which means that the LP-WUS and the SSB have a QCL characteristic, that is, it may be assumed that radio links experienced by the LP-WUS and SSB are the same in aspects of one or more of doppler frequency shift, doppler spread, average delay, delay spread and space reception parameters. In the existing NR system, for an FR1 frequency band, the NR system can support at most 8 analog beams, and for an FR2 frequency band, the NR system can support at most 64 analog beams. A direction of each analog beam is represented by an SSB index, that is, each SSB in an SSB burst set corresponds to one analog beam. An actual number of analog beams used by the base station depends on the number of SSBs actually transmitted in the SSB burst set. Assuming that the LP-WUS is transmitted based on N beam sweepings, the value of N may be determined in one of the following ways:
N is the number of SSBs actually transmitted in the SSB burst set by default, and the beams used by the LP-WUS are associated with the SSBs actually transmitted in the SSB burst set one by one. For example, the first beam of the LP-WUS is associated with the first SSB actually transmitted in the SSB burst set, and so on.
the value of N is preconfigured by the base station, and the value of N is smaller than or equal to the number of SSBs actually transmitted in the SSB burst set. If the value of N is smaller than the number of SSBs actually transmitted in the SSB burst set, the base station also needs to indicate to the UE which SSB index the N beams used by the LP-WUS are associated with respectively, that is, a corresponding beam set is preconfigured for the LP-WUS.

Alternatively, whether there is a QCL relationship between the LP-WUS and the SSB, and what kind of the QCL relationship there is, may be configured by the base station. Alternatively, the LP-WUS does not have a QCL relationship with the SSB, and the number of the beams used for the LP-WUS transmission (i.e., the value of N) is predefined or specially configured by the base station.

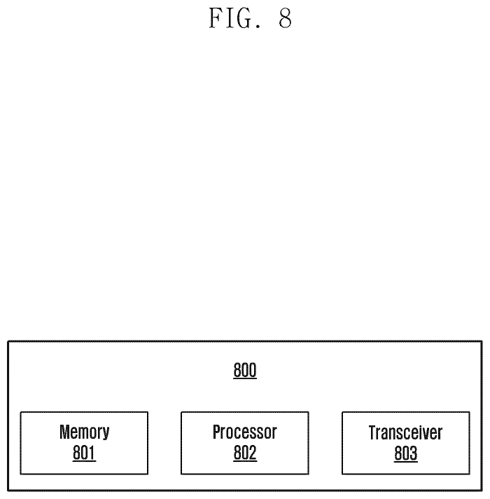

Referring to FIG. 8, a communication device 800 is also provided according to an embodiment of the present disclosure. The communication device includes at least one of a memory 801, a processor 802 and a transceiver 803. The processor is coupled with the transceiver and the memory, and the transceiver is used to receive and/or transmit signals or information. Computer executable instructions are stored in the memory, which, when executed by the processor 602, perform at least one method corresponding to the above various embodiments of the present disclosure. The above description is only the preferred embodiment of the present invention, and is not used to limit the present invention. Any modification, equivalent replacement, improvement, etc. made within the spirit and principle of the present invention should be included in the scope of protection of the present invention.

Those skilled in the art will understand that the present invention includes devices for perform one or more of the operations described in the present application. These devices can be specifically designed and manufactured for required purposes, or they can also include known devices in general-purpose computers. These devices have computer programs stored therein, which are selectively activated or reconfigured.

Such computer programs may be stored in a device (e.g., computer) readable medium or in any type of media suitable for storing electronic instructions and respectively coupled to a bus, where the computer readable medium includes but is not limited to any type of disk (including floppy disk, hard disk, optical disk, CD-ROM, and magneto-optical disk), ROM (Read-Only Memory), RAM (Random Access Memory), EPROM (Erasable Programmable Read-Only Memory), EEPROM (Electrically Erasable Programmable Read-Only Memory), flash memory, magnetic card or optical card. That is, the readable medium includes any medium in which information is stored or transmitted by a device (e.g., a computer) in a readable form.

It will be understood by those skilled in the art that each block in these structure diagrams and/or block diagrams and/or flow diagrams and combinations of blocks in these structure diagrams and/or block diagrams and/or flow diagrams can be implemented by computer program instructions. It can be understood by those skilled in the art that these computer program instructions can be provided to a general-purpose computer, a professional computer or a processor of other programmable data processing methods for implementation, so that the schemes specified in the block or blocks of the structure diagrams and/or block diagrams and/or flow diagrams disclosed in the present invention can be performed by the computer or the processor of other programmable data processing methods.

Those skilled in the art can understand that the steps, approaches and schemes in various operations, methods and flows discussed in the present invention can be alternated, changed, combined or deleted. Further, other steps, approaches and schemes in the various operations, methods and flows already discussed in the present invention can also be alternated, changed, rearranged, decomposed, combined or deleted. Further, the steps, approaches and schemes in various operations, methods and flows disclosed in the present invention of the relevant art can also be alternated, changed, rearranged, decomposed, combined or deleted.

The above description is only part of the implementations of the present invention. It should be pointed out that for those skilled in the art, several improvements and embellishments can be made without departing from the principles of the present invention, and these improvements and embellishments should also be regarded as the scope of protection of the present invention.

1-15. (canceled)

16. A method performed by a user equipment (UE) in a communication system, the method comprising:
receiving, from a base station, a low power wake up signal (LP-WUS) including a first signal associated with a downlink synchronization and a second signal associated with a data signal for carrying related information bits to wake up the UE;
based on the second signal, identifying a first WUS-Data;
based on the first WUS-Data, determining whether there is a WUS-Data to receive in at least one subsequent WUS-Data; and
in case that there is the WUS-Data to receive, receiving, from the base station, the WUS-Data in the at least one subsequent WUS-Data.

17. The method of claim 16, wherein the receiving the WUS-Data further comprising:
based on the second signal, identifying indication information in the first WUS-Data;
based on the indication information in the first WUS-Data, determining whether there is the WUS-Data to receive in the at least one subsequent WUS-Data;
in case that there is the WUS-Data to receive, receiving, from the base station, the WUS-Data one by one until the UE is waked up by the WUS-Data; and
in case that there is no the WUS-Data to receive in the at least one subsequent WUS-Data, determining to skip a reception of the at least one subsequent WUS-Data.

18. The method of claim 16, wherein the receiving the WUS-Data further comprising:
based on the second signal, identifying indication information in the first WUS-Data;
based on the indication information in the first WUS-Data, determining a sequence index of the WUS-Data to receive;
in case that there is the WUS-Data to receive, receiving, from the base station, the WUS-Data corresponding to the sequence index; and
in case that there is no the WUS-Data to receive in the at least one subsequent WUS-Data, determining to skip a reception of the at least one subsequent WUS-Data.

19. The method of claim 17, further comprising:
in case that the UE is waked up by the WUS-Data, starting a physical downlink control channel (PDCCH) monitoring at a preset interval after the LP-WUS,
wherein information bits of the WUS-Data include multiple information blocks,
wherein each of the multiple information blocks corresponds to at least one UE different from the UE, and
wherein the each of the multiple information blocks includes a same number of bits.

20. A method performed by a base station in a communication system, the method comprising:
transmitting, to a user equipment (UE), a low power wake up signal (LP-WUS) including a first signal associated with a downlink synchronization and a second signal associated with a data signal for carrying related information bits to wake up the UE; and
based on a first WUS-Data of the second signal, in case that there is a WUS-Data to transmit in at least one subsequent WUS-Data, transmitting, to the UE, the WUS-Data.

21. The method of claim 20, wherein the transmitting the WUS-Data further comprising:
based on indication information in the first WUS-Data of the second signal, in case that there is the WUS-Data to transmit in the at least one subsequent WUS-Data, transmitting, to the UE, the WUS-Data one by one until the UE is waked up by the WUS-Data; and
based on the indication information in the first WUS-Data of the second signal, in case that there is no the WUS-Data to transmit in the at least one subsequent WUS-Data, determining not to transmit the at least one subsequent WUS-Data.

22. The method of claim 20, wherein the transmitting the WUS-Data further comprising:
based on indication information in the first WUS-Data of the second signal, in case that there is the WUS-Data to transmit in the at least one subsequent WUS-Data, transmitting, to the UE, the WUS-Data corresponding to a sequence index determined based on the indication information; and
based on the indication information in the first WUS-Data of the second signal, in case that there is no the WUS-Data to transmit in the at least one subsequent WUS-Data, determining not to transmit the at least one subsequent WUS-Data.

23. The method of claim 21,
wherein in case that the UE is waked up by the WUS-Data, a physical downlink control channel (PDCCH) monitoring is started at a preset interval after the LP-WUS,
wherein information bits of the WUS-Data include multiple information blocks,
wherein each of the multiple information blocks corresponds to at least one UE different from the UE, and
wherein the each of the multiple information blocks includes a same number of bits.

24. A user equipment (UE) in a communication system, the UE comprising:
a transceiver; and
a controller coupled with the transceiver, wherein the controller is configured to:
receive, from a base station, a low power wake up signal (LP-WUS) including a first signal associated with a downlink synchronization and a second signal associated with a data signal for carrying related information bits to wake up the UE,
based on the second signal, identify a first WUS-Data,
based on the first WUS-Data, determine whether there is a WUS-Data to receive in at least one subsequent WUS-Data, and
in case that there is the WUS-Data to receive, receive, from the base station, the WUS-Data in the at least one subsequent WUS-Data.

25. The UE of claim 24, wherein the controller is further configured to receive the WUS-Data:
based on the second signal, identify indication information in the first WUS-Data, based on the indication information in the first WUS-Data, determine whether there is the WUS-Data to receive in the at least one subsequent WUS-Data,
in case that there is the WUS-Data to receive, receive, from the base station, the WUS-Data one by one until the UE is waked up by the WUS-Data, and
in case that there is no the WUS-Data to receive in the at least one subsequent WUS-Data, determine to skip a reception of the at least one subsequent WUS-Data.

26. The UE of claim 24, wherein the controller is further configured to receive the WUS-Data:
based on the second signal, identify indication information in the first WUS-Data,
based on the indication information in the first WUS-Data, determine a sequence index of the WUS-Data to receive,
in case that there is the WUS-Data to receive, receive, from the base station, the WUS-Data corresponding to the sequence index, and
in case that there is no the WUS-Data to receive in the at least one subsequent WUS-Data, determine to skip a reception of the at least one subsequent WUS-Data.

27. The UE of claim 25, wherein the controller is further configured to:
in case that the UE is waked up by the WUS-Data, start a physical downlink control channel (PDCCH) monitoring at a preset interval after the LP-WUS,
wherein information bits of the WUS-Data include multiple information blocks,
wherein each of the multiple information blocks corresponds to at least one UE different from the UE, and
wherein the each of the multiple information blocks includes a same number of bits.

28. A base station in a communication system, the base station comprising:
a transceiver; and
a controller coupled with the transceiver, wherein the controller is configured to:
transmit, to a user equipment (UE), a low power wake up signal (LP-WUS) including a first signal associated with a downlink synchronization and a second signal associated with a data signal for carrying related information bits to wake up the UE, and
based on a first WUS-Data of the second signal, in case that there is a WUS-Data to transmit in at least one subsequent WUS-Data, transmit, to the UE, the WUS-Data.

29. The base station of claim 28, wherein the controller is further configured to transmit the WUS-Data:
based on indication information in the first WUS-Data of the second signal, in case that there is the WUS-Data to transmit in the at least one subsequent WUS-Data, transmit, to the UE, the WUS-Data one by one until the UE is waked up by the WUS-Data, and
based on the indication information in the first WUS-Data of the second signal, in case that there is no the WUS-Data to transmit in the at least one subsequent WUS-Data, determine not to transmit the at least one subsequent WUS-Data.

30. The base station of claim 28, wherein the controller is further configured to transmit the WUS-Data:
based on indication information in the first WUS-Data of the second signal, in case that there is the WUS-Data to transmit in the at least one subsequent WUS-Data, transmit, to the UE, the WUS-Data corresponding to a sequence index determined
based on the indication information, and based on the indication information in the first WUS-Data of the second signal, in case that there is no the WUS-Data to transmit in the at least one subsequent WUS-Data, determine not to transmit the at least one subsequent WUS-Data,
wherein in case that the UE is waked up by the WUS-Data, a physical downlink control channel (PDCCH) monitoring is started at a preset interval after the LP-WUS,
wherein information bits of the WUS-Data include multiple information blocks,
wherein each of the multiple information blocks corresponds to at least one UE different from the UE, and
wherein the each of the multiple information blocks includes a same number of bits.
